(19) United States
(12) Patent Application Publication
(10) Pub. No.: US 2013/0043858 A1
(43) Pub. Date: Feb. 21, 2013

(54) MAXIMUM POWER POINT TRACKING CIRCUIT GENERIC TO A VARIETY OF ENERGY HARVESTER DEVICES

(71) Applicants: Yogesh K. Ramadass, Dallas, TX (US); Brian P. Lum-Shue-Chan, Palm Bay, FL (US)

(72) Inventors: Yogesh K. Ramadass, Dallas, TX (US); Brian P. Lum-Shue-Chan, Palm Bay, FL (US)

(73) Assignee: Texas Instruments Incorporated, Dallas, TX (US)

(21) Appl. No.: 13/586,557

(22) Filed: Aug. 15, 2012

Related U.S. Application Data
(60) Provisional application No. 61/525,555, filed on Aug. 19, 2011.

(51) Int. Cl. G05F 3/02

(52) U.S. Cl. 323/311

(57) ABSTRACT

A maximum power point tracking circuit for an energy harvester device, the tracking circuit requiring nanoampere current in a standby mode, includes a maximum power point circuits utilizing a predetermined fraction of the open circuit input voltage to determine the maximum power point for energy harvester device. A circuit determines the predetermined fraction of the open circuit voltage of the energy harvester device. A sample and hold circuit measures and holds him the predetermined fraction of the open circuit voltage of the energy harvester device for use by the maximum power point circuit

### CROSS-REFERENCE TO RELATED APPLICATIONS

This patent application claims priority from U.S. Provisional Application No. 61/525,555 filed Aug. 19, 2011, which is incorporated herein by reference in its entirety. This application is related to U.S. patent application Ser. No. 13/______ (TI docket number T70881), filed on even date herewith, and incorporated herein by reference in its entirety.

### FIELD OF THE INVENTION

The invention generally relates to a maximum power point tracking circuit, and more specifically, to a generic maximum power point tracking circuit for micro-power devices.

### BACKGROUND OF THE INVENTION

The utilization of solar cell arrays and wind farms, as well as other means for generating electricity from energy available in the environment is well known. These devices operate most efficiently when operated at their maximum power point, as is well known. Calculating the maximum power point for such devices may involve complex curves and sophisticated processor-based computations. U.S. Pat. No. 7,969,133 and its continuation-in-part application Ser. No. 12/456,776, shows such a system for solar cell arrays.

The term “energy harvesting” has come to mean the obtaining of very small amounts of energy from the environment. The amount of energy involved may be measured in microwatts; for example, 1 μW. The energy harvesting devices can include solar cells, wind power devices, vibration powered piezoelectric devices, and thermoelectric devices, for example. The very small amount of power that is available, rules out utilization of such microprocessor-based solutions.

The advent of ultra-low-power electronics has led to an increasing number of uses for such energy harvesting systems. For example, instead of utilizing cardboard signs to advertise the price of an item for sale in a store, an LCD display device can be utilized which receives such information via a radio signal. The device is powered by a small solar cell mounted within the display. The solar cell provides the necessary power to operate the LCD display without having to have it serviced by store personnel. Another use for micro power devices is in stress sensors for a highway bridge. The sensors can be applied to the bridge structure and powered by the vibrations of vehicles passing over the bridge. This allows them to measure the stress forces within the bridge and report periodically to a central device. The central devices can then alert people as to the status of the bridge, without the necessity of sending a crew to the bridge to make the measurements. Sensors utilized to determine the position of a valve in a high temperature plumbing system can be powered by a thermoelectric device utilizing the temperature differential across the pipes for power. This allows a wireless system to report on the status of the valve without requiring periodic replacement of a battery.

Each of these systems operates from a different type of energy harvester device for power. There is a need for a single maximum power point tracking device that can be utilized with a wide variety of energy harvester devices so that a mass market for these devices will exist allowing for a reduction in the price of each device. It is essential that these devices consume very low power, especially during standby periods.

### SUMMARY OF THE INVENTION

It is a general object of the invention to provide a maximum power point tracking circuit for energy harvesting devices.

In an aspect of the invention, a maximum power point tracking circuit for an energy harvester device, the tracking circuit requiring nanoampere current in a standby mode, comprise a maximum power point circuit utilizing a predetermined fraction of the open circuit input voltage to determine the maximum power point for energy harvester device. A circuit determines the predetermined fraction of the open circuit voltage of the energy harvester device. A sample and hold circuit measures and holds the predetermined fraction of the open circuit voltage of the energy harvester device for use by the maximum power point circuit.

Another aspect of the invention includes a method of determining a maximum power point of an energy harvester device comprising setting a predetermined fraction of an open circuit voltage of the energy harvester device. Measuring and storing the predetermined fraction. Utilizing the predetermined fraction to determine a maximum power point of the energy harvesting device.

A further aspect of the invention includes a system for harvesting power from a micro-power energy harvesting device comprising voltage regulator or charger means for regulating a voltage generated by the energy harvester device, the voltage regulator means being periodically turned off so that an open circuit voltage measurement of the voltage generated by the energy harvester device can be made. An integrated circuit requires nanoampere standby current for determining the maximum power point independent of values of input current or voltage comprising. Means measures a predetermined fraction of the open circuit voltage of the energy harvester device and stores a sample thereof and means to set the predetermined fraction. Memory means sets a sampling time a time between samples.

### BRIEF DESCRIPTION OF DRAWINGS

Further aspects of the invention will appear from the appending claims and from the following detailed description given with reference to the appending drawings:

FIG. 1 is an idealized load curve for solar cell;

FIG. 2 is a block diagram of a solar cell connected to a maximum power point tracking circuit;

FIG. 3 is a schematic of the maximum power point sample and hold circuit;

FIG. 4A is a schematic drawing of the sample and hold circuit, FIG. 4B illustrates the sample and hold signal;

FIG. 5 illustrates a switch design to reduce leakage current across the switch;

FIG. 6 is a schematic block diagram of the maximum power point tracking circuit connected to the charger circuit.

### DETAILED DESCRIPTION OF EXAMPLE EMBODIMENTS

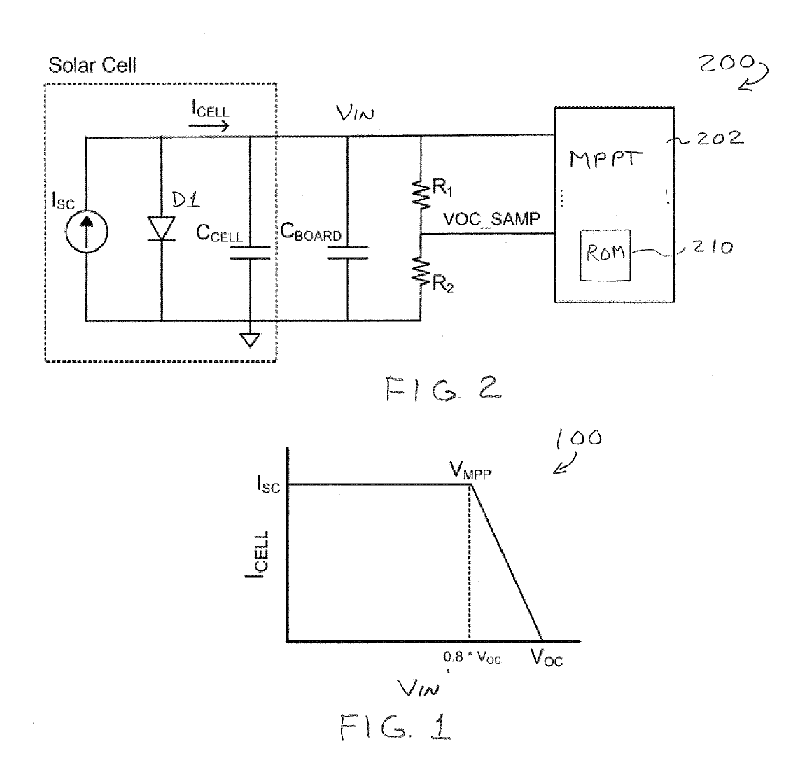

FIG. 1 shows an idealized load curve for a solar cell generally as 100. The voltage generated by the solar cell is shown on the x-axis and the current provided by the solar cell is shown on the y-axis in FIG. 1. The short circuit current Isc remains constant as the voltage increases until the voltage reaches a point Vmpp at which the current begins to decline linearly to zero at the open current voltage Voc. In this idealized situation, the maximum power point is at Vmpp which is at 0.8 Voc. For micro power systems, the utilization of the maximum power point at 0.8 Voc for solar cell energy harvesters is a close enough approximation for a practical solution. This solution avoids the utilization of power-hungry microprocessor circuits. Similar maximum power points can be determined for other types of energy harvesters based on a percentage of the open circuit voltage generated by the harvester. For example, the maximum power point for a vibrational (piezoelectric) harvester may be 0.4 (40%) of the open circuit voltage.

FIG. 2 shows a solar cell energy harvester connected to a maximum power point tracking circuit generally as 200. The solar cell is modeled as a current source Isc coupled in parallel with a diode D1. A capacitor Ccell is in parallel with the current source and the diode to complete the modeled solar cell. A capacitor Cboard is in parallel with the modeled solar cell as is a string of series connected resistors R1, R2. The voltage divider provided by the resistors R1, R2 can be utilized to select the fraction of the open circuit voltage that will be utilized at the maximum power point for the solar cell. If the maximum power point tracking circuit 202 is integrated, at least one of the resistors R1, R2 can be external to the integrated circuit so the user can select the appropriate fraction of the open circuit voltage of the maximum power point of the energy harvester. This allows the user flexibility in using the energy harvester with a variety of energy harvester devices. It is also possible to store values in an internal memory (ROM,EEPROM) 210 on the integrated circuit which can be utilized to select the appropriate fraction for the maximum power point. The output voltage from the solar cell Vin is applied to the maximum power point tracking circuit 202, as is the voltage across the resistor string VOC_SAMP.

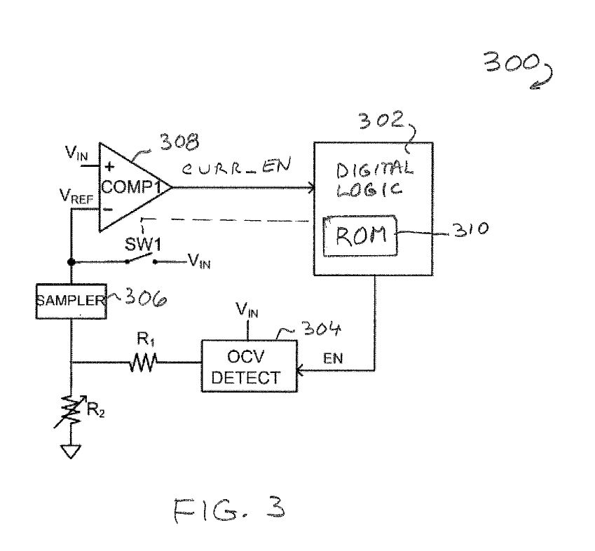

FIG. 3 illustrates the operation of the maximum power point tracking (MPPT) circuit generally as 300. The MPPT switching is controlled by a digital logic circuit 302 which has an output connected to an enable input of open circuit voltage detection circuit 304. The output of the open circuit detection circuit 304 is connected to resistor R1 which is connected in series with variable resistor R2, the distal end of which is connected to ground. Selecting a different value for the resistor R2, such as by changing the resistor, allows for the selection of the appropriate fraction of the open circuit voltage for that particular energy harvester device. The node between the two resistors is connected to a sample and hold circuit 306. The output of the sample and hold circuit 306 is connected to the comparator COMP1, 308 as the reference voltage at the inverting input. The input voltage, Vin, is connected to the non-inverting input of comparator 308.

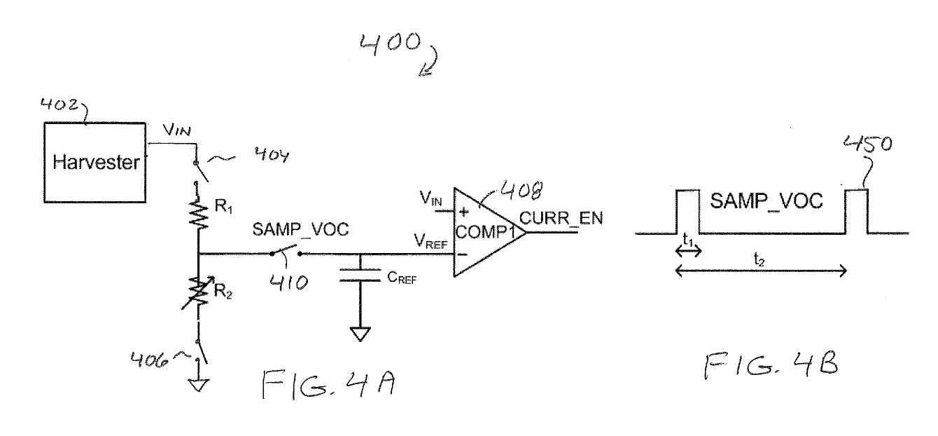

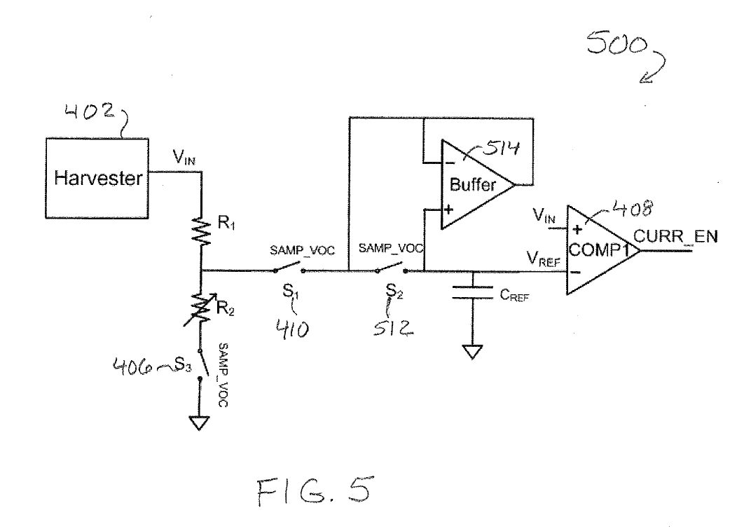

The digital logic circuit 302 controls the operation of the sampling, which will be explained in more detail in connection with FIGS. 4A and 4B, below. When the digital logic circuit 302 determines that it is time to sample the output voltage of the energy harvester device in order to determine the maximum power point, the digital logic circuit will shut off a charger or regulator circuit (not shown in FIG. 3) which provides power to a load. It will then issue an enable signal EN to the turn on the open circuit voltage detection circuit 304. This will allow the input voltage to be applied to the resistor divider R1, R2. The voltage at the node between resistors R1 and R2 is sampled by sample and hold circuit 306 and applied as the reference inverting input of comparator 308. When the input voltage of the circuit is above the value of the reference voltage Vref, the comparator generates an enable signal (CURR_EN) which is utilized by the digital logic circuit to turn on the charging circuit. Thus, the output of the charging circuit is regulated to the maximum power point voltage. The switch SW1 is only used during startup when the voltage at the input is very low. In order to prevent the collapse of the charging circuit, the input voltage is applied as Vref until a voltage threshold is met for Vin. Once the voltage rises to the voltage threshold, the switch is opened by the logic circuit 302 and not utilized in the operation of the MPPT circuit.

FIG. 4A shows the operation of the sample and hold circuit generally as 400. The harvester device 402 has an output Vin which is connected to the series string of resistors R1, R2, via switch 404. The switch 404 is part of the open circuit voltage detection circuit 304 shown in FIG. 3. Alternatively, a switch 406 can be utilized to connect the distal end of resistor R2 to ground or both switches can be utilized. The voltage at the node between the two resistors is sampled by switch 410 to generate a voltage SAMP_VOC which is stored in capacitor Cref coupled between the output of the switch and ground. The voltage across capacitor C ref is applied to the non-inverting input of comparator 408, which corresponds to the comparator 308 shown in FIG. 3. The non-inverting input of comparator 408 is connected to the input voltage Vin. When the input voltage Vin is above the reference voltage Vref, the comparator generates a signal CURR_EN which is used by the logic circuit 302 to turn on the charger and thus regulates the output voltage of a harvester to the maximum power point.

In order to accommodate the fact that the maximum power point changes over time, and in order to minimize the current draw for the maximum power point tracking circuit, a sampling regime as shown in FIG. 4B generally as 450 is utilized. In this sampling regime, the sampling time t1 maybe 256 milliseconds, for example; whereas the time between samples, t2, may be 16 seconds, for example. This allows the maximum power point tracking circuit to adjust for changing conditions while maintaining the current drain at a minimum.

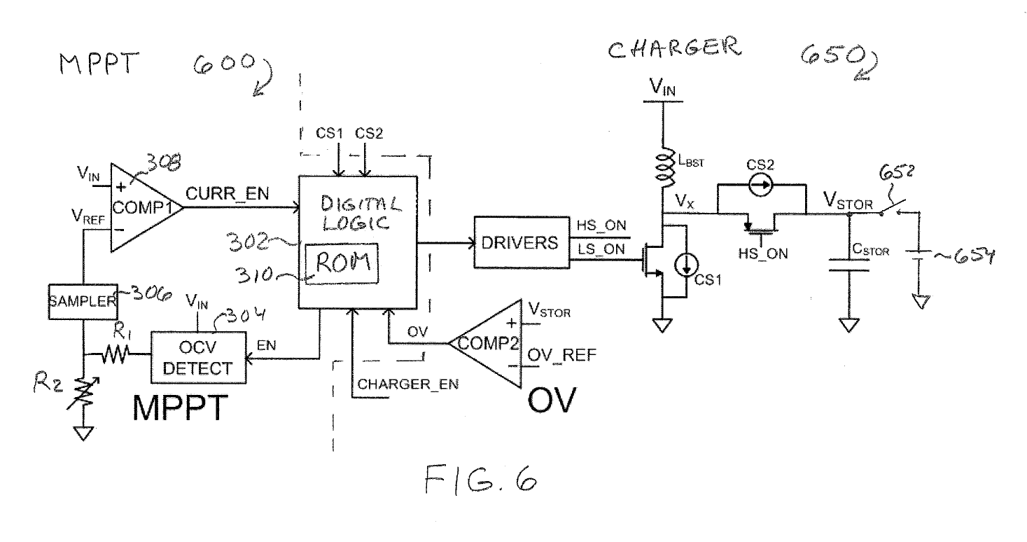

One of the challenges in making this type of circuit work is leakage current across switch 410. This is especially true since the resistors R1,R2 and the capacitor Cref may be external components to an otherwise integrated solution. FIG. 5 illustrates a switch design which radically reduces the leakage current across the switch 410. In FIG. 5, the sampling circuit 400 shown in FIG. 4A is shown generally as 500. In FIG. 5, the harvester 402 has the input voltage connected to the series resistors R1, R2 and switch 406. The circuit can also be used with switch 404, shown in FIG. 4 or with a combination of both switches 404 and 406. The node between resistors R1 and R2 is connected to two sampling switches 410, 512 both controlled by the signal SAMP_VOC. The sample voltage at the node between resistors R1 and R2 is stored in a capacitor Cref, which may be an external capacitor may have a value of 10 nF, for example. The voltage across capacitor Cref supplied to the voltage reference (inverting) terminal of comparator 408. The output of comparator 408 is the signal CURR_EN referred to above in the description of FIG. 4 and discussed further below connection with FIG. 6. In order to reduce the leakage current through the sampling switch from capacitor Cref, a second switch 512 placed in series with the switch 410. A buffer 514 has its noninverting terminal connected to the Cref side of switch 512 and its inverting input connected to the node between the switches 410 and 512. The inverting input of the buffer 514 is connected directly to its output. Thus, the buffer will work to maintain a 0 V level across the switch S2, 512. If the switch 512 is implemented using an NMOS transistor, the maintaining of a zero voltage level across the transistor will dramatically reduce the leakage current through the transistor from the capacitor Cref. The buffer 514 can be designed to draw only 10 nanoamperes of current. Although this add slightly to the current drain for the maximum power point tracking circuit, it enables the samples to be taken at greater time intervals, which, in turn, reduces the average current drain for the maximum power point tracking circuit. By turning off the current through resistors R1,R2 and minimizing the leakage across the switch 410, the maximum power point tracking circuit can have average input current of 50 nanoamperes, for example.

FIG. 6 illustrates the connection of the maximum power point tracking circuit shown generally at 600 with a charger circuit shown generally at 650. The maximum power point tracking circuit 600 is illustrated with the elements shown in FIG. 3: digital logic circuit 302 with its internal read only/read mostly memory 310, open circuit voltage detection circuit 304, resistors R1 and R2, sample and hold circuit 306 and comparator 308. The elements of the charger circuit 650 are shown in detail and explained in co-pending application 13/______ (TI-70881), filed on even date herewith, and incorporated herein by reference in its entirety. As can be seen from FIG. 6, when the input voltage is above the predetermined maximum power point, comparator 308 generates a signal CURR_EN which causes digital logic circuit to output a signal to the drivers of the charger 650. The driver circuit operates the two transistors to generate a voltage which is stored in capacitor Cstor, which can be utilized to charge a battery.

A battery 654 is connected to the capacitor Cstor by switch 652 which can be closed whenever the voltage on capacitor Cstor exceeds the battery voltage and the battery is in need for charging.

Although the invention has been described in detail, it should be understood that various changes, substitutions and alterations can be made thereto without departing from the spirit and scope of the invention as defined by the appended claims.

1. A maximum power point tracking circuit for an energy harvester device, the tracking circuit requiring nanoampere current in a standby mode, comprising:
a maximum power point circuit utilizing a predetermined fraction of the open circuit input voltage to determine the maximum power point for energy harvester device;
a circuit to determine the predetermined fraction of the open circuit voltage of the energy harvester device; and
a sample and hold circuit for measuring and holding the predetermined fraction of the open circuit voltage of the energy harvester device for use by the maximum power point circuit.

2. The maximum power point tracking circuit of claim 1 further comprising a voltage regulator coupled between the energy harvester device and a load.

3. The maximum power point tracking circuit of claim 2 wherein the voltage regulator is periodically turned off so that an open circuit voltage measurement can be made.

4. The maximum power point tracking circuit of claim 3 further comprising an internal read only memory for setting a sampling time and a time between samples.

5. The maximum power point tracking circuit of claim 1 wherein the determination of the maximum power point is independent of the values of input voltage or input current.

6. The maximum power point tracking circuit of claim 1 wherein the energy harvester device is one of the groups consisting of a solar cell, a thermoelectric generator, a piezoelectric device, a radio frequency receiver and a wind driven generator.

7. The maximum power point tracking circuit of claim 2 wherein power is supplied to a battery or a super capacitor coupled to an output of the voltage regulator.

8. A method of determining a maximum power point of an energy harvester device comprising:
setting a predetermined fraction of an open circuit voltage of the energy harvester device;
measuring and storing the predetermined fraction;
utilizing the predetermined fraction to determine a maximum power point of the energy harvesting device.

9. The method of claim 8 further comprising regulating voltage generated by the energy harvester.

10. The method of claim 9 further comprising periodically turning off the voltage regulator so that an open circuit voltage can be measured.

11. The method of claim 10 further comprising setting a sample time and a time between samples based on information stored in an internal read only or read mostly memory.

12. The method of 8 wherein determination of the maximum power point is independent of the values of the input voltage or input current.

13. The method of claim 8 wherein the energy harvester device is one of the groups consisting of a solar cell, a thermoelectric generator, a piezoelectric device, a radio frequency receiver and a wind driven generator.

14. The method of claim 8 wherein power is supplied to a battery or a super capacitor coupled to an output of the voltage regulator.

15. The method of claim 13 wherein power is supplied to a battery or a super capacitor coupled to an output of the voltage regulator.

16. A system for harvesting power from a micro-power energy harvesting device comprising:
voltage regulator or charger means for regulating a voltage generated by the energy harvester device, the voltage regulator means being periodically turned off so that an open circuit voltage measurement of the voltage generated by the energy harvester device can be made;
an integrated circuit requiring nanoampere standby current for determining the maximum power point independent of values of input current or voltage comprising:
means for measuring a predetermined fraction of the open circuit voltage of the energy harvester device and storing a sample thereof and means to set the predetermined fraction;
memory means for setting a sampling time and a time between samples.

17. The system of claim 16 wherein the means to set the predetermined fraction comprises a resistor external to the integrated circuit.

18. The system of claim 16 wherein the voltage regulator means is formed on the integrated circuit.

19. The system of claim 18 wherein the energy harvester device is one of the groups consisting of a solar cell, a thermoelectric generator, a piezoelectric device, a radio frequency receiver and a wind driven generator.

20. The system of claim 19 wherein power supplied to a battery or a super capacitor coupled to an output of the voltage regulator.
